(19) United States
(12) Patent Application Publication
(10) Pub. No.: US 2008/0276317 A1
(43) Pub. Date: Nov. 6, 2008

(54) Detection of Multi-Step Computer Processes Such as Network Intrusions

(76) Inventors: Varun Chandola, Minneapolis, MN (US); Eric Eilertson, Roseville, MN (US); Haiyang Liu, Blaine, MN (US); Mark Shaneck, St. Paul, MN (US); Changho Choi, St. Paul, MN (US); Gyoergy Simon, St. Louis Park, MN (US); Yongdae Kim, Plymouth, MN (US); Vipin Kumar, Plymouth, MN (US); Jaideep Srivastava, Plymouth, MN (US); Zhi-Li Zhang, Minneapolis, MN (US)

Correspondence Address: SCHWEGMAN, LUNDBERG & WOESSNER, P.A., P.O. BOX 2938, MINNEAPOLIS, MN, 55402, US

(21) Appl. No.: 11/794,941

(22) PCT Filed: Jan. 10, 2006
(86) PCT No.: PCT/US06/00715

§ 371 Date: Apr. 7, 2008

Related U.S. Application Data
(60) Provisional application No. 60/642,649, filed on Jan. 10, 2005.

(51) Int. Cl. G06F 21/00

(52) U.S. Cl. 726/23

(57) ABSTRACT

Multi-step processes such as intrusions into computer networks are detected from individual activities or events such as communications by identifying anchor points (FIG. 2, 220) that are likely to be part of the process, proceeding from the anchor points to extract other activities as a context of the anchor points, and characterizing the process from the activities in the context. The process may be characterized as sets of context activities.

### TECHNICAL FIELD

The present subject matter relates to electronic data processing, and more specifically concerns detection of multi-step processes, such as attacks upon networked computers

### BACKGROUND

Attacks upon computers connected to each other in networks are becoming more widespread and more sophisticated. Attackers may act from a variety of motives, including destruction of content on the networked computers, obtaining files, passwords, or other sensitive information from the computers, impairing the computers' access to the network, and spying on the computer users' activities.

Common internet attacks include worms, viruses, and distributed denial-of-service (DDoS). These usually generate large volumes of network traffic, and take place over relatively short periods of time. Other attacks, however, may occur in multiple steps over longer periods of time, and may never involve large amounts of data. They may enmesh a number of hosts, including both outside hosts and compromised hosts inside the network of the target computer. As an example, a hacker may use several dozen computers on the internet to perform a distributed scan of computers in a limited-access network. After the scan finishes, a different set of computers may attempt various exploits on the targeted network, followed by yet another computer subverting an exploited computer to cause the now compromised computer in the protected network to send private information to an external computer that is under the hacker's control. None of these steps need involve a large amount of data, and the steps may occur over hours, days, or weeks.

### SUMMARY

Although multi-step attacks may not betray themselves by rapid or intense data transfers, individual events in the attacks may exhibit anomalous behaviors that deviate from normal host/service profiles, or may involve suspicious communications activities between the attackers and their victims. The invention performs a shallow analysis of voluminous network-wide sensor data to identify anchor points for in-depth follow-on analysis in a more focused context. Spatial/temporal chaining analysis and event sequencing may extract and characterize the context of an attack, and may employ behavior-based host profiling and flow-anomaly analysis.

The invention may also find utility in detecting or recognizing multi-step processes besides network intrusions. The methodology may also, for example, monitor communications over computer, telephone, or other channels for detecting criminal activity, terrorist groups—looking for keywords in conversations, which phone numbers called others at what times, and may employ blacklists of known suspicious numbers. On a less negative note, the methodology may untangle involved financial transactions.

### DRAWING

FIG. 1 is a block diagram of a networked environment for an attack-detection system.

FIG. 2 is a high-level block diagram of an illustrative attack-detection system.

FIG. 3 is a flowchart of an example method for detecting network attacks.

FIGS. 4A-4C are diagrams showing stages in the detection of a multi-step network attack.

### DESCRIPTION

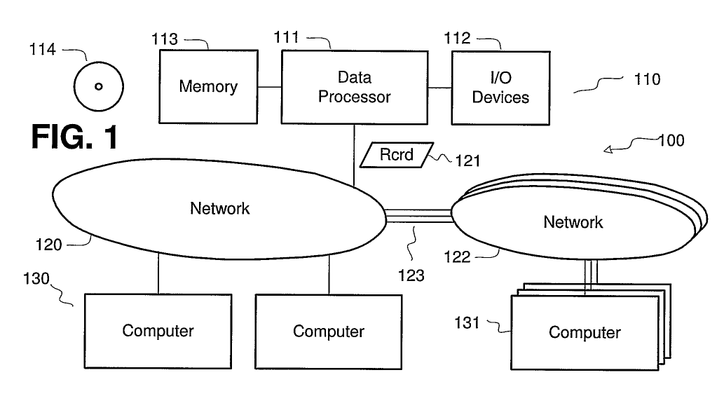

FIG. 1 depicts a representative environment including the invention. Environment 100 has a computer 110 connected to a protected network 120, along with other computers or other machines 130. Each computer may include the components shown for computer 110, such as a data processor 111 and a memory 112. Memory 112 may include internal and external memory. Disc 113 symbolically represents an external medium that may carry instructions and data for executing the invention. Input/output devices 114 may include representative input devices such as keyboards and pointing devices; illustrative output devices may comprise printers and displays. Interface 115 links computer 110 to the network. This network may comprise a network such as a local area network (LAN) or a wide-area LAN (WLAN) for transferring communications among multiple computers or machines such as 110 and 130. to each other. The communications may take many forms, and will be described herein as records 121. Computers 110 and 130 may comprise any combination of personal computers, hosts, servers, and other machines coupled to network 120 for transmitting and receiving data. Network 120 may serve a business, a government agency, or other facilities.

Although network 120 has limited access for security purposes, it may connect to multiple other networks 122, either directly or via inter-network gateways 123. These networks may comprise LANs, WLANs, the Internet, etc. Other machines (servers, hosts, etc.) connect to networks 122. A multi-step attack on network 120 may arise in networks 122 or within network 120 itself, and may involve machines in any or all of the networks.

An intrusion system according to the invention may reside on computers in network 120 that also serve other purposes. Data collection for the system may be deployed where network 120 interfaces with other networks 122, and at peering points internal to network 120 as well, if desired. Collected data may be analyzed in a small number of computers in network 120; it may be possible to perform the entire analysis for a network of a thousand machines on a single workstation-class computer.

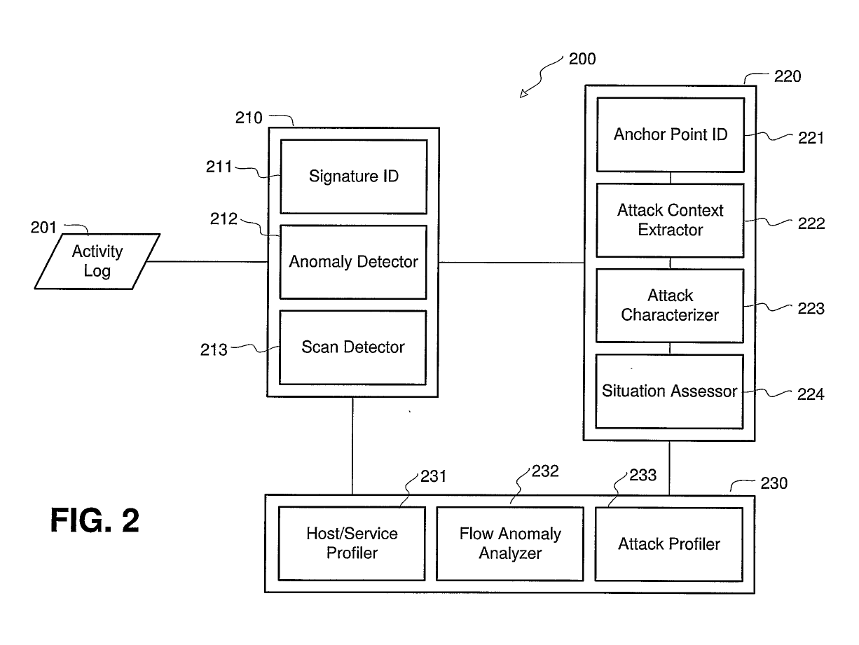

FIG. 2 shows an intrusion detection system 200 for detecting attacks on network 120—that is, on any or all of the machines 110, 130 in the network. For purposes of this example, assume that computer 110 hosts system 200, and may receive records sent to or from other machines 130 in the network. The records may be stored in an activity log 201 in memory 113 or in some other device. Activity log 201 may save the times, sources and destinations, or other pertinent features of the records.

Detector array 210 includes multiple detectors which may be disposed at computers 130, at gateways 123, or at other locations to receive network records 121 that travel to or from computers 110, 130. Detectors 210 identify records that are suspicious as potentially parts of an attack against the computer. Block 210 shows multiple types of detectors that may look for different kinds of activities.

Block 211 indicates one or more signature identifiers. Anti-virus and other products store signature code that has been distilled from known threats. The stored code is matched against records to identify these threats. Some products may further heuristically identify record code as being similar to a known threat. One or more anomaly detectors 212 may identify records having features that seem not to be parts or normal communications. Copending commonly assigned patent application Ser. No. 11/302,989, filed Dec. 14, 2005, illustrates a convenient anomaly detector. One or more scan detectors 213 search for other computers that may be conducting port scans on computer 110. Such scans are often presage an attack. Some products may combine different detection modes. For example, the Snort® intrusion-detection system (IDS), publicly available from Sniort.org, employs a rules-driven language that combines the benefits of signature, protocol, and anomaly methods. Other types of intrusion detectors may also be included in unit 210.

Detector array 210 sends suspicious records identified as part of an attack or intrusion for further processing to the location of the analyzer-computer 110 in this example. Computer 110 may receive all of the traffic on the protected network, although only some of the records are flagged for analysis. Detection of individual suspicious records is called Level I analysis in some security communities, such as the United States department of defense.

Situational analyzer 220 examines the records found by detectors 210 in order to link records together into a multi-step process; this aspect is sometimes known as Level II analysis.

An anchor-point identifier 221 singles out one or more of the suspicious records the record to serve as starting points of an attack analysis—although these are not usually the starting point of the attack itself. Unit 221 usually finds more than one anchor point. Additional anchor points frequently speeds up the analysis of what actually happened in the attack, and may lend confidence to the final output. Different anchor points may belong to a single attack or to multiple attacks; a single anchor point may even belong to more than one attack. The goal of anchor-point identification is to increase effectiveness and efficiency by performing a broad but shallow initial analysis to identify a few likely candidates, rather than performing an in-depth analysis upon every suspicious record. Anchor-point identification is deliberately somewhat loose. Anchor points are a winnowing tool to cut down the number of transaction sequences that need to be investigated fully.

Communication with a host on a previously generated watch list may be flagged as an anchor point. An anchor point may be noted when a host engages in suspicious activity, for example, a communication bearing an IDS signature such as a Snort alarm. Another form of suspicious activity may include behavior anomalies such as send/receive traffic from a host that is anomalous with respect to historical profiles. Certain behavior signatures may also be tagged as suspicious activities. Examples include hosts that perform port scans, that engage in port-knocking sequences, or that attempt to run services such as FTP or SSH from ports that are not standard in the industry. A communication between a host and a known compromised computer, or any other identifiable behavior of a known compromised machine, may be tagged as suspicious behavior, and thus as an anchor point.

Block 221 may combine data and correlate output records from multiple detectors 210. Block 221 may also access host, service, or flow profiles from later analysis stages or from outside sources, attack signatures, or other outside information, rules, or algorithms.

Context extractor 222 proceeds from an anchor point to identify other records or entities that belong to the same possible attack. Other entities may include non-record data such as IP addresses and ports within the record. Extractor 222 may identify hosts, flows between multiple machines, transactions, or other events or activities that are involved in the same attack. Extractor 222 searches activities from each identified anchor point in order to build a set of events that belong to the same attack, according to a set of rules or guides. Anchor points need not be connected with each other by communications records. In such cases, identifier 221 or extractor 222 may divide the anchor points into groups and derive a separate context for each group.

The context search may be recursive; that is, the criteria or rules for finding the next activity may depend upon which activities have been found thus far in the search. Implementations for this block may include a profile-based chaining analysis, such as looking through tcpdump, net flow, or other data to determine what other IP addresses that computer might have communicated with. These addresses in turn may be investigated for another round of context extraction, for a number of iterations.

However, pursuing an ever-widening search naively may degrade performance without a concomitant gain in accuracy. Therefore, some or all iterations in the search may embrace techniques such as profiling or anomaly detection to perform additional iterations only upon points that are themselves suspicious. That is, the context search may be limited or narrowed by other criteria. For example, a user may normally employ a workstation to check e-mail, read news feeds, etc. If this computer were hacked, it may suddenly communicate with a computer in another country on a random port. Thus, only this non-normal activity need be included in the context. Profile-based chaining may assume many forms. Simple profiles may list hosts that each computer normally talks with, and which services are used. More complex profiles may include how different services are used, volumes, frequencies, and directions of data transmissions, or times of the day or week.

As an example of a context search, assume an anchor-point host attempts a remote log-in to a Web server which then transfers files via the FTP protocol to a third machine. A rule might infer that the server and the third machine are in the context of the anchor host. Rules or other devices may operate to exclude some records or machines from consideration. For example, for terminal services, a rule set may exclude source-port identifiers <1024, or transmissions having <4 packets, or destination-port identifiers <3389, or protocols other than TCP.

Search techniques may include domain-specific or otherwise guided searches. A network may have a number of computers that have been hacked from different sources for different reasons, not all of which need be evil. For example, attacks involving port 139 TCP (networking on the Microsoft Windows® operating system) may be of no interest, while traffic involving port 3389 TCP (terminal services) may be of great concern. In some embodiments, an algorithm or a user may select or ignore classes of records based upon many different features, such as protocol, port number, record size (bytes/packet), data volume per session, time, or duration. Sometimes, interest in a particular type of traffic may not become known until after the analysis is underway; therefore the system may dynamically or interactively modify the search criteria. When suspicious activity of a certain type is found, further analysis may concentrate on this type of behavior. For example, if computers identified as scanners are also found to be involved in Internet relay chat (IRC) with suspicious computers, further analysis may focus upon traffic on IRC ports.

Host activities may be added to the chain of an attack if they deviate from a norm established by the profile of that host, or if they deviate from its service/port profile. For example, profiles may include which ports, protocols, or combinations are typically used; or how much data is transferred, in which direction, or which host initiates the transfer. Host activities may also or alternatively include activities that are similar to known suspicious communications, such as replies to port scans, messages sent from known compromised hosts, or attack signatures. Attack signatures may include items such as specific words appearing in a record or a particular sequence of network connections. Attack signatures may be generated within system 200, by an outside system, or by a human analyst.

Block 222 outputs the set of records (or pointers to them) that form parts of the same attack—or it may conclude that the activities including the anchor point are not in fact an attack.

Block 223 may characterize the attack, either according to a computer-based algorithm or manually by an operator. Block 223 determines likely relationships between particular hosts and events that have been retained as part of the context in block 222. It may evaluate and rank hosts and activities in the attack context to retain those with a high degree of suspicion, and to prune those having a low degree of suspicion. Techniques may include temporal sequencing analysis, knowledge-based event labeling, and pattern matching with known attacks.

Sample rules for attack characterization may include items such as: (1) If a host is scanning, label it an attacker with a low score or probability. (2) If a scanned host replies to the scan, label it as a victim with a medium score. (3) If a host internal to the network is scanning other machines, label it hacked with a high probability. (4) If an internal host is labeled as hacked and subsequently transfers a file outside the network, increase the probability that it has been hacked, and label the target host an attacker with a high score. Block 223 may output a labeled set of records or events as a characterization of the attack. The characterization may include where the attack originated, or which computers were compromised, subverted, or otherwise victimized.

Assessment block 224 may evaluate the attack characterizations that block 223 produces. Evaluation may include estimates of the attack's severity, possible courses of action, and formulation of new attack signatures, etc. Although computer-based algorithms may perform assessment functions, present incarnations of system 200 output the characterizations to a human user for assessment and further action.

Blocks 230 represent tools employed in system 200. They may include host/service profilers, analyzers of network-wide flows, attack profilers or signature generators, or others. These tools may gather information from any source in blocks 210 or 220, or externally to system 200, either entered automatically or manually. Their outputs may include scores indicating degrees of anomaly from normal parameters, amount of fit with known patterns, for example, and may change dynamically during operation of the system. Profiles, signatures, etc. may be fed back for use in blocks 221-224, as described above. They may also be fed back for dynamically improving the operation of detector array 210, if desired. For example, the identity of a compromised host found in block 223 may be fed back to block 221 for use in determining subsequent anchor points.

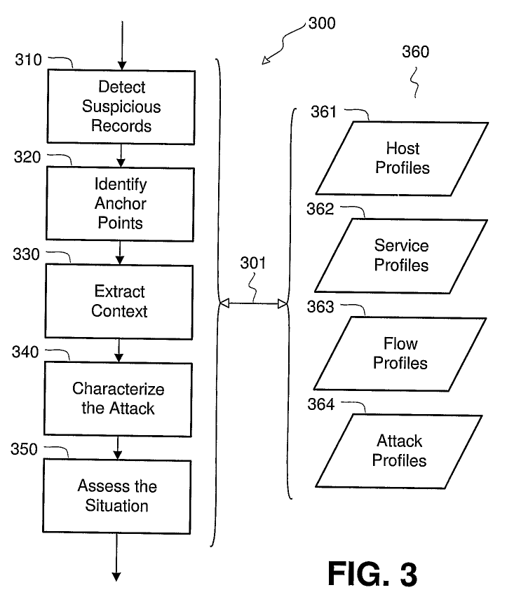

FIG. 3 shows a method 300 for detecting multi-step intrusions into computer networks. The method may operate in batch mode (such as hourly) on a sect of recent activity-log records, or in an on-demand mode, or in a continuous real-time streaming mode. New anchor points and context records may be added dynamically as new records or other information becomes available.

First-level block 310 detects individual suspicious records, by their contents, by their sources and destinations, or by other means. Block 310 passes these records to block 320 for a second-level analysis.

Block 320 labels one or more of the records as anchor points of a suspected attack. Such anchor-point records need not initiate or terminate the attack; they are merely more likely than others to form a part of an attack according to predetermined criteria applicable to the intended use. Block 320 may be tuned so that, for example, an alert from one source may not designate an anchor point unless it is corroborated from another source. Criteria may come from any part of the system, and may change with time. Multiple anchor points may be output as a single attack, or divided into groups if there is not enough evidence to link them together. Later operations, such as 340 or 350, may rectify incorrect decisions by block 320.

Block 330 extracts a context of the attack by tracing other records to and from the anchor points, or from each group of anchor points. Block 330 may recursively examine records from other machines, starting from one or more of the anchor points. Records in the context need not necessarily be included in the suspicious records detected by block 310; a record that is not is not suspicious in and of itself may become so by linking to an anchor point or to another record in the context. Block 330 produces a list of context records.

Block 340 analyzes the context records to characterize the suspected attack that involves them. Block 340 may determine sequencing and other probable relationships among the context records, and may rank host machines and activities in the context. Block 340 produces a list of labeled attack sequences. Block 340 may determine that one or more of the context records appear not to form part of the attack, so that the attack records may differ from the list of context records.

In this example implementation, block 350 presents the characterization to a user to assess the situation, update profiles, etc., and take action.

Blocks 310-340 may employ rules and algorithms in their operation. The method also accumulates various kinds of historical data in blocks 360 for use by the method. For example, block 361 indicates profiles of various hosts that lie within network 120, or that communicate with machines in network 120. Profiles may include data on the usual operations of individual computers such as known bad computers, or more global profiles, such as a typical secretaries' or executives' machines. Block 362 may comprise tables or databases of service profiles—that is, services and ports accessed in network hosts. Block 363 may store profiles of record flows among machines in network 120 or with machines in other networks 122, to establish norms for normal or usual traffic patterns. Block 364 may store profiles or signatures from past attacks for comparison with current patterns.

Arrow 301 travels in both directions. That is, method 300 makes use of data gathered in the blocks 360, but the method operations also contribute to this data. For example, blocks 340 or 350 may produce new attack signatures that become part of an attack-profile database 364.

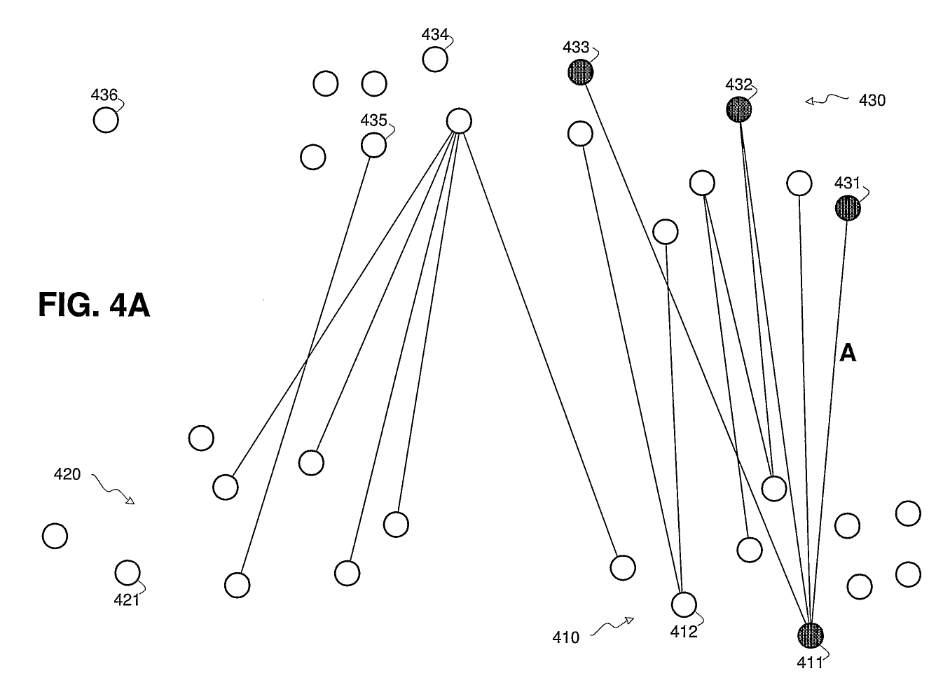

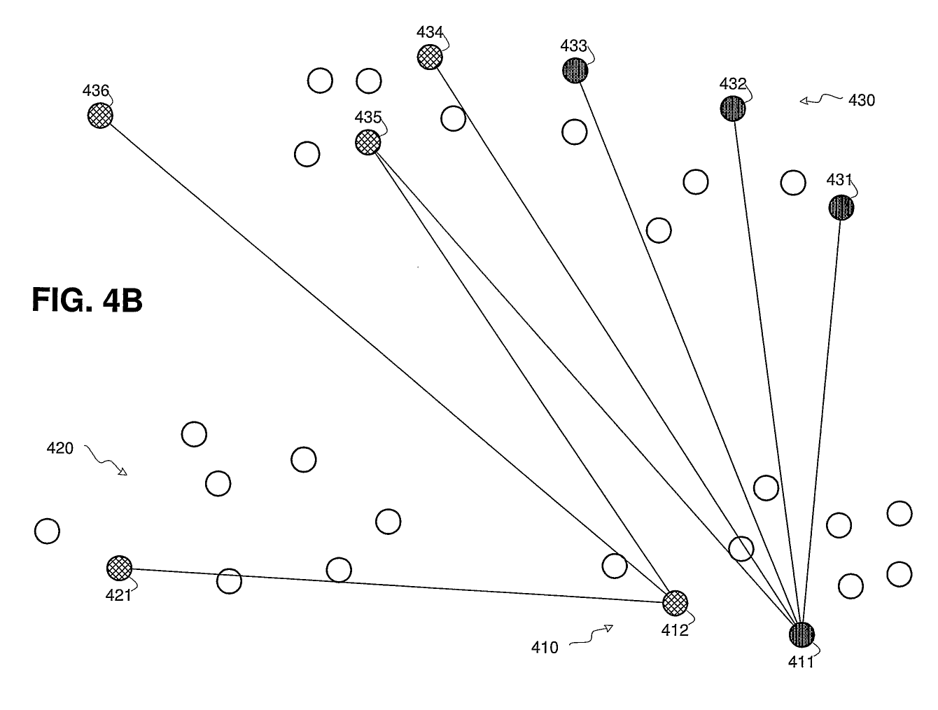

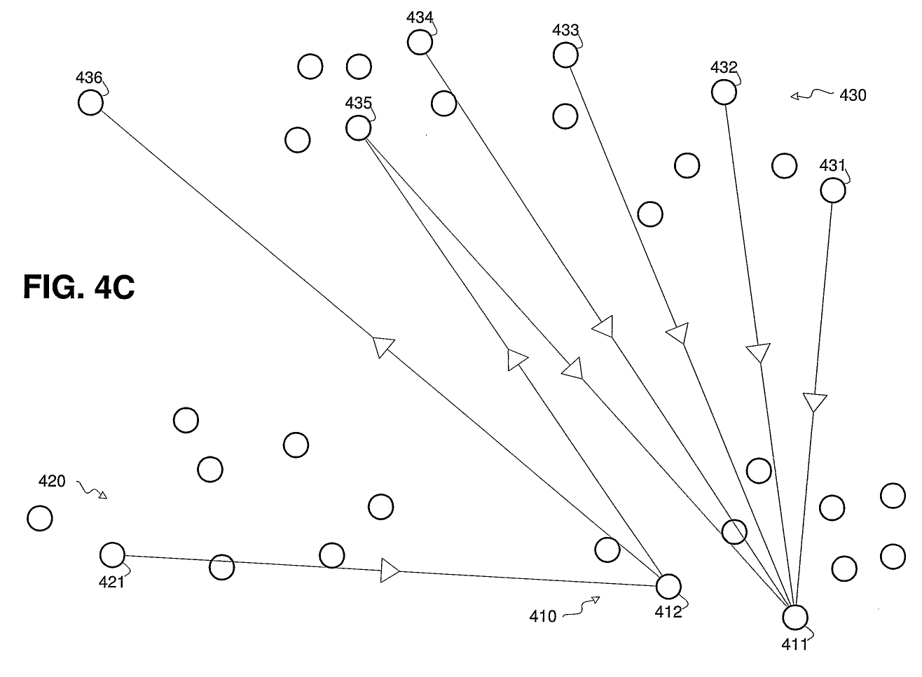

FIGS. 4A-C describe a simplified example of detecting a multi-step misdirection attack involving three groups of machines. The first group 410 lies within a first subnetwork to be protected. The second group 420 comprises remote users of another protected subnetwork. The third group 430 comprises machines in networks external to the first and second groups, not part of the protected network. The circles indicate hosts in the various networks.

FIG. 4A illustrates a selection of anchor points according to blocks 320 and 221, FIGS. 2 and 3. The lines between nodes represent communications records that are suspicious because they have produced Snort alerts involving IP addresses that exhibit anomalous behavior—for example, that is that do not follow the protocol. In addition, the record between Web server 411 and 431 has a high anomaly ranking, symbolized by an “A.” The records between machines 411 and 432 and between machines 411 and 433 have a high anomaly in the sense determined by the aforementioned pending application Ser. No. 11/302,989; of the connections they are similar to they are not as similar to them as they are to each other. These activities engage rules that classify machines 411 and 431-433 as anchor points of a probable attack, indicated by a heavy crosshatch in FIG. 4A.

FIG. 4B shows the generation of a context from the anchor points, as may take place in blocks 22 and 330. Chaining paths from the anchor points reveals that machine 434 made a failed remote log-in attempt to server 411. Note that this communication did not produce a Snort alert in FIG. 4A. Further chaining reveals that context machine 435 had scanned machine 412 in network 410, had received a reply, and had initiated a connection on port 8080, with a medium anomaly ranking, thus making 412 suspicious enough to include in the context. Investigating machine 412 then shows that Web server 436 had initiated FTP (file-transfer protocol) connections to machine 412, enough to add machine 436 to the growing context. Further tracking from machine 412 then exposes a remote log-in from machine 421 in network 420. In FIG. 4B, the lines represent records chained in determining the context, and the light crosshatch represents machines that are included in the attack context. The anchor points are embraced in the context by definition.

FIG. 4C characterizes the attack, as in blocks 223 and 340. Open arrowheads in FIG. 4C denotes flow directions of the lines that represent records involved in the context. The following table sets forth a characterization of the misdirection attack in terms of the time sequence of record transfers between the numbered machines, and the nature of the transferred records.

| SEQ | TRANSFER | NATURE |
|---|---|---|
| 1 | 433 to 411 | Bad HTTP traffic |
| 2 | 431 to 411 | Bad HTTP traffic |
| 3 | 432 to 411 | Bad HTTP traffic |
| 4 | 435 to 411 | Scan with reply |
| 5 | 434 to 411 | Remote log-in failed |
| 6 | 431 to 411 | Remote log-in failed |
| 7 | 421 to 412 | Remote log-in succeeded |
| 8 | 412 to 436 | Anomalous FTP |
| 9 | 412 to 435 | Anomalous port 8080 transfer |

Record events 1-3 attempted to attack machine 411 to install the hacker's software there. Event 4 checks computer 411 for a specific open port. In events 5-6, machines 434 and 431 later checked to determine whether the attack was successful; but it was not. This exploit, check, log-in is typical in a misdirection attack. The attack achieved success at events 7-9, when a dial-up host 421 hacks into Web server 412 via remote log-in, and initiates anomalous file transfers from machine 412 to external hosts 435 and 436, where 435 had earlier scanned other machines. Note that, at the anchor-point identification stage of FIG. 4A, the remote log-in by machine 421 had not even been identified as suspicious, much less as the instigator of the attack. Further, the file transfer to machine 436 had not been the subject of an alert; it was only later fingered as one of the recipients of an illicit file transfer from the protected network 120.

### CONCLUSION

Concepts disclosed include apparatus and methods carried out in a digital computer for automatic recognition of processes in a computer or other network by analyzing one or more logs of network activity generated from identifying a set of activity-log records as anchor points which comprise signatures (either probabilistic or deterministic) of the processes being recognized. Other activity-log records that were potentially generated by the processes being recognized are extracted as also belonging to the process; these are context records of the process. The context records are described or characterized; the description may take the form of a Markov model, or as a list of labeled and sequenced context records. The context may be refined by excluding some of the previously identified context records. The constructed process may relate to intrusions of a computer network, telephone communications among criminal conspirators or terrorists, complex financial transactions such as money laundering, or other multi-step processes.

Anchor points may be identified from records flagged as part of the process by single-event detectors, or by combining the results of one or more detection techniques, including alarms generated by standard signature-based intrusion detection systems, behavior-anomaly detection systems, behavioral signature-based detection systems, watch-list/black-list monitoring systems, and so on.

Behavioral signatures for intrusion detection may consider many different types of factors, such as hosts that communicate with known compromised machines, hosts that perform scans or port knocking, services running on non-standard ports, or any other identifiable behavior of a known compromised machine.

Context extraction may take as an input a set of anchor points, and use them as starting points to create the process context by collecting other activity-log records that are related to the anchor points. For example, context extraction may start from an anchor point and recursively examine activity with other hosts that deviates from a normal host profile or service/port profile, that replies to scans, that is similar to known suspicious traffic attack signatures, or that involves records from known compromised hosts.

Characterizing the process may convert the process context into a description of the process. Characterization may determine likely relationships (e.g. sequencing) between retained events and hosts, or may evaluate or rank hosts or activities in the process context to retain those with high degree of suspicion and prune those with low degree of suspicion.

The foregoing description and drawing illustrate certain aspects and embodiments sufficiently to enable those skilled in the art to practice the invention. Other embodiments may incorporate structural, process, and other changes. Examples merely typify possible variations, and are not limiting. Portions and features of some embodiments may be included in, substituted for, or added to those of others Individual components, structures, and functions are optional unless explicitly required, and operation sequences may vary. The word “or” herein implies one or more of the listed items, in any combination, wherever possible, and does not exclude items not in the list. The required Abstract is provided only as a search tool, and not for claim interpretation. The scope of the invention encompasses the full ambit of the following claims and all available equivalents.

We claim as our invention:

1. A method for detecting multi-step intrusions into computer networks from activity-log records, comprising:
detecting a first set of the activity-log records as being parts of an attack on the network;
identifying a subset of the first set of records as anchor points in the attack;
extracting a subset of the activity-log records as a context of the attack, in response to the anchor point records.

2. The method of claim 1 where extracting includes searching the activity-log records from the anchor points.

3. The method of claim 2 where the searching is recursive from the anchor points.

4. The method of claim 1 further comprising:
dividing the anchor points into multiple groups;
extracting the context of the attack from only one of the groups of anchor points.

5. The method of claim 1 where at least one of the activity-log records in the context is not a record in the first set of activity-log records.

6. The method of claim 1 further comprising characterizing the attack.

7. The method of claim 6 where characterizing includes labeling at least one host as an attacker, as a victim, or as being hacked.

8. The method of claim 6 further comprising assessing characterizations produced by characterizing the attack.

9. The method of claim 8 where assessing includes producing labeled sequences of events among hosts that form at least a part of the attack.

10. The method of claim 8 where assessing includes pruning at least one record from the context of the attack.

11. The method of claim 1 where at least one of the identifying or extracting operations employs at least one of the items from of a group consisting of host profiles, service profiles, flow profiles, or attack profiles.

12. A computer readable medium including instructions for causing a computer to perform a method comprising:
detecting a first set of the activity-log records as being parts of a multi-step process;
identifying a subset of the first set of records as anchor points in the process;
extracting a subset of the activity-log records as a context of the process, in response to the anchor point records.

13. The medium of claim 12 where the computer process is an attack on at least one of a plurality of computers connected to a network.

14. The medium of claim 12 further comprising producing, in response to the context records, a labeled sequence of those of the activity-log records involved in the process.

15. Apparatus for detecting a multi-step computer process represented by a set of activity-log records, comprising:
an array of multiple detectors for detecting a first subset of the set of activity-log records as suspicious records belonging to the process;
a situational analyzer for identifying certain of the suspicious records as anchor points of the process, and for searching the set of activity-log records beginning with the anchor-point records to extract a second set of the activity-log records as context records belonging to the process.

16. The apparatus of claim 15 where different ones of the detectors employ different algorithms for detecting suspicious records.

17. The apparatus of claim 16 where the situational analyzer is responsive to multiple ones of the detectors to identify the suspicious records.

18. The apparatus of claim 15 where the activity-log records comprise communications between a plurality of networked computers.

19. The apparatus of claim 18 where the array and the analyzer are disposed in a host computer connected to one network of multiple interconnected networks.

20. The apparatus of claim 19 where the host computer receives all communications to all of the computers in the one network.

21. The apparatus of claim 18 where the computer process comprises an attack on at least one of the networked computers.

22. The apparatus of claim 15 where the situation analyzer produces a labeled sequence of the activity-log records that participate in the process.

23. The apparatus of claim 22 where the labeled sequence need not include all of the context records.
